(19) United States
(12) Patent Application Publication
(10) Pub. No.: US 2025/0264321 A1
(43) Pub. Date: Aug. 21, 2025

(54) NANOMETROLOGY DEVICE

(71) Applicant: NATIONAL UNIVERSITY OF SINGAPORE, Singapore (SG)

(72) Inventors: Cheng-Wei QIU, Singapore (SG); Zhipeng LI, Singapore (SG)

(73) Assignee: NATIONAL UNIVERSITY OF SINGAPORE, Singapore (SG)

(21) Appl. No.: 19/059,830

(22) Filed: Feb. 21, 2025

(30) Foreign Application Priority Data
Feb. 21, 2024 (SG) 10202400466U

(51) Int. Cl. G01B 9/02018; G01B 11/14

(52) U.S. Cl. CPC G01B 9/02018; G01B 11/14

(57) ABSTRACT

A device measures nanoscale displacements of an object positioned in an optical cavity aligned with each dimension sought to be measured. Each optical cavity receives light from a direction corresponding to a respective dimension, and includes an optical absorber for increasing sensitivity of the optical cavity.

### CROSS-REFERENCE TO RELATED APPLICATIONS

This application claims the benefit and priority of Singaporean patent application number 10202400466U, filed Feb. 21, 2024. The entire disclosure of the above application is incorporated herein by reference.

### TECHNICAL FIELD

The present invention relates, in general terms, to nanometrology devices. In particular, the invention relates to, but is not limited to, devices for detecting nanometre scale displacements of objects.

### BACKGROUND

This section provides background information related to the present disclosure which is not necessarily prior art.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Many modern nanofabrication technologies need precise displacement monitoring. Often, monitoring is desirable down to 1 nanometre displacements. Typical nanometrology method uses light, providing a displacement monitoring resolution of about half of the wavelength of the light—this is generally several hundred nanometres. This includes nanomicroscopy techniques, these being generally limited to detection in a single plane—no, three-dimensional detection.

To reduce resolution down to 1 nm, shorter wavelength light is used, such as X-ray or electron beam. Use of such light requires complicated electronic or photonic components to generate high-quality short wavelengths. Other methods use multibeam interference to generate superoscillatory fields or optomechanical oscillation. However, multibeam interference needs a large number of optical components, precise alignment of components, complicated three-dimensional nanostructures and rigorous manipulation of multiple optical beams. The whole system is consequently bulky and noise-sensitive. An alternative monitoring methodology uses nanopatterns to eliminate multibeam control, but this requires precise fabrication of nanopatterns.

It would be desirable to provide a simple and low-cost nanometrology method for advanced nanofabrication technologies that overcomes problems of prior art nanometrology technologies, or at least provides a useful alternative.

### SUMMARY

This section provides a general summary of the disclosure, and is not a comprehensive disclosure of its full scope or all of its features.

Disclosed is a device for measuring nanoscale displacements of an object, comprising: a body; at least one optical cavity formed in the body, each optical cavity being positioned to receive light from a direction corresponding to a respectively different dimension of the object to be measured; and for each cavity, an optical absorber positioned in the respective cavity.

The at least one optical cavity may comprise three optical cavities, each optical cavity positioned for alignment with a respectively different one of three orthogonal axes of the object to the measured. The three optical cavities may define an overlap portion for receiving the object, the overlap portion being common to all three optical cavities. The overlap portion may comprise substantially the entirety of each cavity.

The device may include a light source aligned with each cavity (one light source that is movable for alignment with all cavities, or one light source per cavity, that may be in fixed alignment with the respective cavity), for emitting light towards the object such that the light passes from the object to the optical absorber in the respective cavity.

Each optical cavity may comprise a pair of mirrors. Each pair of mirrors includes a first mirror and a second mirror and, for each cavity, the optical absorber may be positioned closer to the first mirror than the second mirror. In such embodiments, the device includes at least one light source aligned with each cavity, for emitting light through the respective second mirror towards the respective first mirror.

The pair of mirrors can be a pair of Bragg grating mirrors and the optical absorber may comprise an Er3+-doped quartz crystal.

The device can form a cavity for receiving the object—it can be any appropriate length, such as 3 cm long. That cavity may be the overlapped portion mentioned above.

Also disclosed is a system including the abovementioned device, a light source for alignment with each cavity, for emitting light towards the object, a detector system for detecting an oscillation frequency of each optical cavity, and a processor for converting each detected oscillation frequency to a displacement along the respective dimension corresponding to the respective optical cavity.

The detector system (including, e.g., an Indium Gallium Arsenide (InGaAs) detector) may detect two oscillation frequencies of each cavity and the processor then determines the displacement along each respective dimension by determining a frequency shift between the two oscillation frequencies. The detector system can convert light, modulated by the object, to an electrical signal corresponding to the oscillation frequency of each optical cavity, the processor processing each electrical signal to determine the displacement along the respective dimension corresponding to the respective optical cavity.

As used herein, the term “dimension” refers to a dimension in an orthogonal or orthonormal set of dimensions.

Advantageously, the device includes a single optical cavity in each dimension. Despite its resulting simplicity, the device enables robust displacement detection in up to three-dimensions with 1-nm resolution.

Advantageously, each cavity houses an optical absorber to enable high-sensitivity detection. This configuration avoids the need for multibeam control and complex nanopatterns of prior art detection methods.

Advantageously, the system incorporating the device is simple, robust, and low cost. It can therefore be used in a wide of applications including nanofabrication, microscopy, and biodynamics.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Embodiments of the present invention will now be described, by way of non-limiting example, with reference to the drawings in which:

FIG. 1 shows a device in accordance with present teachings, for making nanoscale measurements—e.g., of nanoscale displacements.

FIG. 2 schematically illustrates the experimental setup for 1-nm metrology in a single dimension.

FIG. 3 provides results for 1-nm metrology in one dimension.

Corresponding reference numerals indicate corresponding parts throughout the several views of the drawings.

### DETAILED DESCRIPTION

Example embodiments will now be described more fully with reference to the accompanying drawings.

Disclosed is a method to detect displacements down to 1 nanometre using a device with a single optical cavity in each dimension—i.e., each dimension to be measured. The devices can eliminate the technical need for nanopatterns and multibeam interference. An optical absorber is inserted into the optical cavity to enhance sensitivity. This invention can be widely adopted for nanometric metrology with low cost and high robustness.

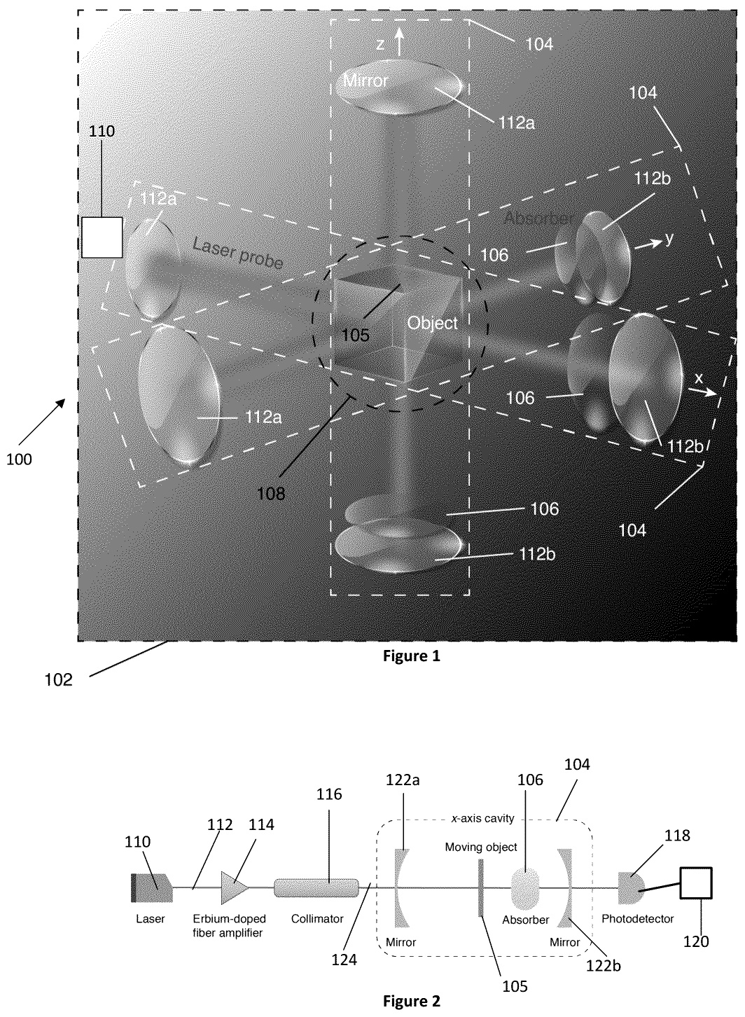

Such a device 100 is shown in FIG. 1. The device 100 is used for measuring nanoscale displacements of an object. The device 100 includes a body 102, and optical cavities 104 formed in the body. Each optical cavity 104 contains an optical absorber 106.

The body 102 is represented by a dashed line. The body 102 houses at least the optical cavities (one of which is generally encircled by dashed line 104 aligned with the x-axis, the other two optical cavities being aligned along the mutually orthogonal y- and z-axes) and, in use, the object 105. The body 102 may fully enclose the optical cavities 104, or partially enclose the optical cavities 104. By enclosing the optical cavities 104, the body 102 prevents ambient light from interfering with displacement measurements.

In some applications, it is necessary only to measure in a single dimension-such an arrangement is schematically represented in FIG. 2. In this instance, a single optical cavity may be provided, aligned with the desired direction of measurement, and corresponding single optical absorber in the cavity. In other applications it is necessary to measure in two dimensions. For illustration purposes, the device 100 described herein includes three optical cavities and corresponding absorbers, for making nanoscale measurements—e.g., measurements of displacement—in three dimensions.

Each optical cavity is positioned to receive light from a direction corresponding to a respectively different dimension of the object to be measured. There is therefore a single cavity per dimension, each cavity having an optical absorber.

The optical cavities 104 can have any appropriate dimensions. In the example in FIG. 1, the cavities 104 are centimetre-sized—e.g., 3 cm in each dimension (i.e., between the mirrors of each cavity).

The optical absorber 106 in the cavities enhances sensitivity of the cavities. In some embodiments, enhancement is over 100 times. In this regard, the resonant frequency of each cavity 104 is used to characterize the sensitivity. The resonant frequency can be altered by changing the optical absorber. Thus, in some configurations, the wavelength of light emitted from the light source, the dimensions of the optical cavity and the optical absorber are selected to optimise displacement sensing in a particular range—e.g., 0.1 micrometer scale sensing, down to 1 nanometer or other range.

The device comprises three optical cavities with the length of 2l−l is thus half the cavity length, which can be particularly useful where the object 105 is positioned halfway along each cavity in the direction being measured. In each dimension, one cavity translates the displacement signal to the oscillating frequency of the cavity.

In effect, the object 105 in the cavity can act as a mirror, with part of the light reflected and part of the light transmitted through. Thus, when the object moves, the resonant frequency of the cavity changes. These frequency changes are associated with wavelengths of light at the respective frequencies, changes in these wavelengths (or, similarly, the analogous frequencies) are thus proportional to displacements of the object.

The three optical cavities 104 define an overlap portion (generally designated 108) for receiving the object 105. The overlap portion 108 is common to all three optical cavities 104—i.e., each optical cavity 104 defines a respective volume. Part of that volume is common to all of the optical cavities 104. The object 105 is placed in that common volume so that its displacement can be simultaneously determined for as many dimensions are being measured. In effect, a cavity (that is common to all cavities 104) is formed by the device 100, for containing the object 105 during displacement measurement. That common volume or cavity can have dimensions optimised for the wavelength of light being used, such as 3 cm in each dimension.

The device 100 further comprises a light source 110. The light source 110 may be any appropriate source, such as a laser. When a laser is used, the wavelength of light emitted from the laser may be 1550 nm, or any appropriate wavelength. Higher wavelengths may facilitate detection of smaller displacements. Moreover, multiple light sources may be used for a cavity, if it proves advantageous to do so—e.g., different light sources more accurately detect displacements of particular magnitudes or work better with different materials used for the object.

The light source 110 is aligned with a cavity 104. In some embodiments, a single light source 110 may be used—e.g., by moving the light source 110 such that it is sequentially aligned with each cavity 104, or using two beam splitters to split the beam into three beams, with one beam being directed in a direct line from the light source 110 along the axis of one optical cavity, and mirrors to reflect two of the beams along the axes of the other two optical cavities. Alternatively, there may be one light source per optical cavity.

With reference to FIG. 2, light 112 from the light source 110 is emitted towards the object 105, so that light passes from the object 105 (e.g., through the object) to the optical absorber 106 in the cavity 104. While light 112 may pass directly from the light source 110 to the object, the light presently passes through one or both of an amplifier 114 and a collimator 116. The amplifier 114 amplifies the light 112 emitted from the light source 110, while the collimator 116 focusses the rays (forming the light 112) from the light source 110 such that they exit the collimator 116, towards the respective optical cavity 104, in parallel.

On the opposite side of the optical cavity 104, relative to the light source 110, is a detector system 118. The detector system 118 detects an oscillation frequency of each optical cavity 104. To that end, the detector system 118 converts light, modulated (e.g., frequency, amplitude or phase shifted) by the object 105, to an electrical signal corresponding to the oscillation frequency of each optical cavity 104 or of the object 105. A processor 120 then converts each detected oscillation frequency (the oscillation frequency being represented by an electrical signal produced by the detector system 118) to a displacement along the dimension (axis) corresponding to the optical cavity 104.

The detector system 118 includes a detector or photodetector. The detector may be an Indium Gallium Arsenide (InGaAs) detector, or other suitable detector (e.g., Germanium (Ge) detector). In some embodiments, the detector system 118 detects two oscillation frequencies for each cavity, the processor 120 determining the displacement along each dimension by calculating the frequency shift between the two oscillation frequencies.

With further reference to FIG. 2, the optical cavity 104 includes a pair of mirrors 122a, 122b. The pair of mirrors 122a, 122b are aligned with the axis along which displacement in the cavity 104 is being measured. The mirrors 122a, 122b, of the embodiment shown in FIG. 2 are concave with respect to the object 105. The concave mirrors 122a, 122b may therefore be centred on the light 122 being emitted from the light source 110—in some embodiments, the mirrors 122a, 122b are centred on the collimated beam 124 emitted from the collimator 116. Notably, the concave mirrors 122a, 122b are thinnest where the collimated beam 124 enters the cavity 104. The light 112 or collimated beam 124 (or beam emitted from the amplifier) passes through one of the mirrors 122a. For each optical cavity 104, the optical absorber 106 is positioned closer to one mirror 122b than the other mirror 122a, and the light source aligned with the cavity emits light through the other mirror 122a, towards the object 105, optical absorber 106 and mirror 122b near the optical absorber 106.

To enable light to pass through the mirror 122a, that mirror 122a may be fabricated to apply band-pass filtering to the light. For example, the mirror 122a may be a Bragg grating mirror. In some embodiments, both mirrors 122a and 122b are Bragg grating mirrors. The optical absorber 106 may be formed from any appropriate material, such as Erbium-based Er³⁺.

It will be apparent in view of present teachings that the device 100 can be used in a system, and is designed to be used in such a system, that also includes the light source or light sources, detector system and processor for converted detected oscillation frequencies to displacements along respective axes.

Due to the transflective properties of the object in the cavity centre, two oscillating modes exist in each cavity. The reflection (reflection coefficient) and transmission of the object are r and t=\sqrt{1−r²}, respectively. An optical absorber, denoted as γ, is inserted into the cavity. Once the object is displaced by Δx, the field amplitudes of the two oscillating modes, a₁ and a₂, can be described by the scattering matrix:

$$( \begin{matrix}{a}_{1} \\ {a}_{2}\end{matrix} ) = ( \begin{matrix}{re}^{- 2 ik ( l + Δ x )} & {te}^{- 2 ik ( l + Δ x )} \\ {te}^{- 2 i ( k - i γ ) ( l - Δ x )} & {re}^{- 2 i ( k - i γ ) ( l - Δ x )}\end{matrix} ) ( \begin{matrix}{a}_{1} \\ {a}_{2}\end{matrix} ) . \qquad ( 1 )$$

The two oscillating modes are determined by the change of position (displacement) of the object, since the object is semitransparent—i.e., partially emits light and partially reflects light. Two oscillating modes or frequencies are detectable for each cavity—these modes may correspond to the closest and furthest positions of the object with respect to the optical absorber, and may be accompanied by other modes (that can be disregarded) between those two positions.

The displacement can thus be detected by measuring the resonant frequency shifts Δ_{±}=ck/2π−v₀, where c is the speed of light, v₀ the resonant frequency without displacement, and k optical wavenumber. Solving above equation, the oscillating frequency shifts of two modes are:

$${Δ}_{\pm } = - \frac{[ Arg ( {u}_{\pm } / r ) + 2 m π ]}{π} , \qquad ( 2 )$$

where u_{±}=ξ±\sqrt{ξ²−1} and ξ=|r| cos h 2ikΔx+γ(1−Δx). To enhance the response of frequency shifts, the system is operated at a singularity point where the two resonant frequencies degenerate. This singularity exists where the two oscillating frequencies of x-axis cavity become the same. Before measuring the displacement, the cavity may therefore be calibrated to operate at the singularity. When u₊=u₋, the conditions of this singularity point can be obtained as γ_{EP}=cos h⁻¹(1/|r|)/l and Δx=nλ/4. Considering a subtle displacement in nanoscale, the resonant frequency shift is a square-root function with the displacement Δ_{±}∝\sqrt{Δx}. However, if the inserted optical absorber is absent γ=0, above equation becomes Δ_{±}∝Δx². This result indicates that this invention provides an efficient tool to enhance the detection of a tiny displacement down to 1 nanometer.

The implementation of above theory in the device of FIG. 1 relies on three orthogonal optical cavities. Each optical cavity consists of a selective reflector—for example, a pair of Bragg grating mirrors. The reflectivity of the selective reflector is ideally close to 1, such as a reflectivity of 0.999 for the Bragg grating mirrors. The cavity length in each dimension of the example embodiment is 3 cm. A 6-mm cubic quartz crystal inside the cavity is the moving object to be detected. This moving mirror (object the displacement of which is being measured) is coated with a reflective film on one side and an antireflection film on the other side—i.e., in some embodiments, the object may have a body formed from a transparent material, that is coated to impart the necessary reflective and transmissive properties. In each dimension, an additional Er³⁺-doped quartz crystal is inserted into the cavity as the absorber. A laser at 1550 nm is used to probe the oscillation frequency of the cavity. The displacement of the moving mirror is obtained by monitoring the oscillation frequency of the cavity through a photodetector in each dimension. The photodetector is the device that receives the signal corresponding to the oscillating frequency of the cavity—e.g., from the optical absorber. This signal is used to interpret the amount of displacement. Thus, each dimension should have a photodetector—similarly, each dimension may have an amplifier and collimator. The photodetector may be any appropriate photodetector, such as a InGaAs detector operating at 800 nm to 1700 nm, for converting light energy into electrical signals.

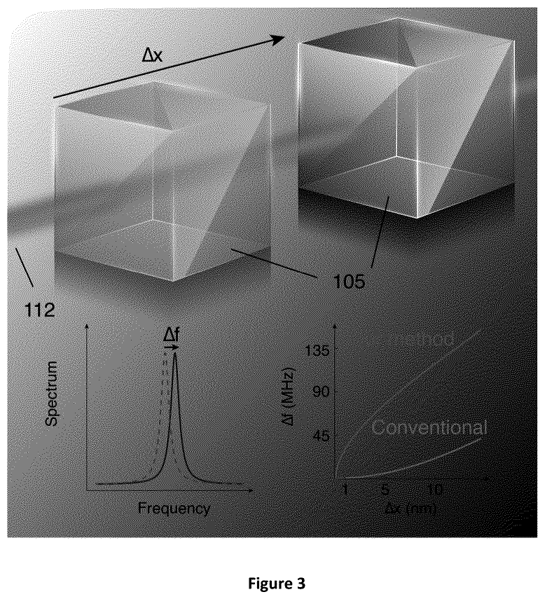

The results of displacement detection in x-dimension are shown in FIG. 3. When the object moves 1 nm, the cavity frequency shifts 29.5 MHz. The sensitivity is enhanced by a factor of 150 when compared with the cavity without the absorber.

Applications for the devices disclosed herein include precise displacement detection in the fields of nanofabrication, microscopy, and biodynamics.

It will be appreciated that many further modifications and permutations of various aspects of the described embodiments are possible. Accordingly, the described aspects are intended to embrace all such alterations, modifications, and variations that fall within the spirit and scope of the appended claims.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

1. A device for measuring nanoscale displacements of an object, comprising:
a body;
at least one optical cavity formed in the body, each optical cavity being positioned to receive light from a direction corresponding to a respectively different dimension of the object to be measured; and
for each cavity, an optical absorber positioned in the respective cavity.

2. The device of claim 1, wherein the at least one optical cavity comprises three optical cavities, each optical cavity positioned for alignment with a respectively different one of three orthogonal axes of the object to the measured.

3. The device of claim 2, wherein the three optical cavities define an overlap portion for receiving the object, the overlap portion being common to all three optical cavities.

4. The device of claim 1, further comprising a light source aligned with each cavity, for emitting light towards the object such that the light passes from the object to the optical absorber in the respective cavity.

5. The device of claim 1, wherein each optical cavity comprises a pair of mirrors.

6. The device of claim 5, wherein each pair of mirrors comprises a first mirror and a second mirror and, for each cavity, the optical absorber is positioned closer to the first mirror than the second mirror, the device comprising at least one light source aligned with each cavity, for emitting light through the respective second mirror towards the respective first mirror.

7. The device of claim 5, wherein the pair of mirrors is a pair of Bragg grating mirrors.

8. The device of claim 1, forming a cavity for receiving the object.

9. The device of claim 8, wherein the cavity for receiving the object is 3 cm long.

10. The device of claim 1, wherein each optical absorber comprises an Er³⁺-doped quartz crystal.

11. A system for measuring nanoscale displacements of an object, comprising:
a device according to claim 1;
a light source for alignment with each cavity, for emitting light towards the object;
a detector system for detecting an oscillation frequency of each optical cavity; and
a processor for converting each detected oscillation frequency to a displacement along the respective dimension corresponding to the respective optical cavity.

12. The system of claim 11, wherein the detector system detects two oscillation frequencies of each cavity and the processor determines the displacement along each respective dimension by determining a frequency shift between the two oscillation frequencies.

13. The system of claim 12, wherein the detector system comprises an Indium Gallium Arsenide (InGaAs) detector.

14. The system of claim 11, wherein the detector system converts light, modulated by the object, to an electrical signal corresponding to the oscillation frequency of each optical cavity, the processor processing each electrical signal to determine the displacement along the respective dimension corresponding to the respective optical cavity.

15. The system of claim 11, further comprising an amplifier for amplifying the light emitted from the light source.

16. The system of claim 11, further comprising a collimator for focusing rays from the light source such that they exit the collimator, towards the respective optical cavity, in parallel.
